(19) United States
(12) Patent Application Publication
(10) Pub. No.: US 2017/0144784 A1
(43) Pub. Date: May 25, 2017

(54) Method for Valve-Controlled Filling

(71) Applicant: Endress + Hauser Process Solutions AG, Reinach (CH)

(72) Inventor: Andreas Illi, Basel (CH)

(21) Appl. No.: 15/309,591

(22) PCT Filed: May 20, 2015
(86) PCT No.: PCT/EP2015/061140

§ 371 Date: Nov. 8, 2016

(30) Foreign Application Priority Data
May 26, 2014 (DE) 10 2014 107 364.9

(51) Int. Cl. B65B 3/36; G01F 5/00; G01F 15/00; G01F 15/02; B67C 3/20; B67C 3/28

(52) U.S. Cl. CPC B65B 3/36; B67C 3/20; B67C 3/287; G01F 15/001; G01F 15/005; G01F 15/02; G01F 5/00

(57) ABSTRACT

A method for valve-controlled filling of a defined amount of fill of a medium into a container, wherein during a filling procedure, based on a measurement signal, preferably a pulse signal, representing a flow amount, a flow rate of the medium is ascertained, and wherein based on a change of the flow rate during the filling procedure a point in time for closing a valve, which serves for filling, is corrected during the filling procedure.

The invention relates to a method for valve-controlled filling of a defined amount of fill of a medium into a container. Furthermore, the invention relates to a filling apparatus and a computer program, respectively a computer program product.

In many applications, e.g. in the foods industry or in the pharmaceuticals industry, it is necessary to fill a defined amount of fill of a medium, e.g. yogurt or a medicine, reproducibly into a containment, for example, into a container such as a bottle. From economic reasons, it is besides the filling of an always constant amount of the medium into the containment also highly desirable, when an individual filling procedure takes as little time as possible and when, moreover, the individual filling procedures follow in time quickly one after the other.

In order to assure the reproducibility of the amount of the medium filled into the containment, in the case of known filling procedures, a valve in a supply line is opened at a given point in time. The volume-, respectively the mass flow of the medium is determined with a volume flow measuring device, respectively with a mass flow measuring device. In the case of the volume flow measuring device, it can be, for example, a PROMAG 53, respectively a DOSIMAG II, flow measuring device. As mass flow measuring device, for example, a PROMASS 83, respectively a DOSIMASS II, flow measuring device can be applied. The above mentioned device types are sold by the applicant. Based on the flow value delivered by the measuring device, the amount of fill is determined. As soon as the predetermined amount of the medium has been filled into the containment, the valve is closed. The valve opening amount, respectively the valve closing amount, thus the amount of fill, which is filled into the containment in the case of not completely opened, respectively closed, valve, is determined based on experiential values, respectively based on experimentally ascertained values, and taken into consideration in the filling procedure.

A high reproducibility of the amount of fill filled into a containment is important in two ways: If the amount of fill does not correspond to the minimum amount set forth on the containment, then legal penalties threaten the operator of the process installation; in contrast, if the amount of filling lies above the amount to be filled, then the filler has possibly to face considerable negative financial effects.

A corresponding method for filling a defined amount of medium into a container is known from Offenlegungsschrift DE 10149473. In such case, the valve opening amount and/or the valve closing amount of the medium are/is determined and the opening and/or closing of the valve is so controlled that the defined amount of fill of the medium is filled into the containment.

Also known from Offenlegungsschrift DE 102005008041 is a method for the metered filling of a flowable medium. In such case, the device- and medium-specific valve closing amount is detected and this is taken into consideration as a correction in subsequent fillings, so that the actual fill amount corresponds to the desired fill amount.

Likewise known from Offenlegungsschrift DE 102008018089 is a method for the filling of a medium, in the case of which method the flow velocity of the medium is set as a function of a measured temperature.

Additionally, it is known from Offenlegungsschrift DE 102005052197 to detect air bubbles for safe filling in a filling plant using valve control.

In Offenlegungsschrift DE 2831624 of Michael Ziesemer and Peter Haug, a method for dosing or metering of flowing media is provided, in the case of which a pulse signal representing the flow of the medium is fed to a counter and upon reaching a pre-selected value a signal for terminating the dosing or metering procedure is produced.

Also known from patent DE 10306751 is a method for filling a medium, in the case of which, based on a pressure pK, a correction factor K is ascertained, by which correction factor the time for filling an adjustable amount is determined.

In practice, however, it has turned out that the aforementioned filling methods are always still too inaccurate, since, for example, the problem occurs, that the closing behavior of the valve is only the same from one dosing or metering cycle to the next, when the volume- or mass flow has not changed. Change can, however, result, for example, from higher pressure in the supply tank or when only a portion of the valves in the filling plant are open.

An object of the invention is to provide an improved method for filling a defined amount of fill into a container, such as a bottle.

The invention is achieved by a method, a filling apparatus and a computer program, respectively a computer program product.

As regards the method, the object is achieved by a method for valve-controlled filling of a defined amount of fill of a medium into a container, wherein during a filling procedure based on a measurement signal, preferably a pulse signal, representing a flow amount (total flow) a flow rate of the medium is ascertained, and based on a change of the flow rate during the filling procedure a point in time for closing a valve, which serves for filling, is corrected during the filling procedure, preferably as a function of change of the flow rate.

As already described, methods for valve-controlled filling of a defined amount of fill are known from the state of the art. While in the state of the art, however, a constant flow rate during the filling procedure is assumed (at least after complete opening of the filling valve), according to the invention the flow rate during the filling procedure, preferably after the complete opening of the filling valve, is taken into consideration, for example, by registering and evaluating the flow amount and/or the flow rate by means of a control unit, in order to control, respectively to correct, the point in time for closing the filling valve. The terminology, filling procedure, refers, in such case, to the filling as well as also the time span of the filling of the container with the provided medium.

The terminology, flow amount, means, in such case, for example, the mass, for example, in kg, registered by means of a flow measuring device respectively the volume, for example, in m³, registered by means of a flow measuring device. Serving as measurement signal, in such case, can be the above mentioned pulse signal. In such case, a pulse can correspond to a predetermined amount, for example, 2 ml. The total flow amount can then, in turn, be determined by registering the number of pulses. The flow rate, on the other hand, refers to a volume or mass, which flows per unit time through a certain cross-sectional area, i.e. dM/dt, respectively dV/dt, and is usually given in kg/s, respectively m³/s.

Based on the progression of the pulses, i.e., for example, based on a period of time lying between two pulses, the flow rate can be determined. In the case of a change of the flow rate, especially also the valve closing amount will change, i.e. the flow amount which accumulates in the container between the signal for closing the valve (close command) and the actual point in time, at which the valve actually becomes closed.

In spite of the fact that a valve closing correction is known per se in the case of valve-controlled filling, it is, in such case, so far not known to take into consideration a changing flow rate during the filling procedure (after the complete opening of the filling valve) for determining, respectively for correction of, the point in time for closing the valve during the same filling procedure.

In a form of embodiment of the method, in the case of a change of the flow rate during the filling procedure, which change lies above a predetermined threshold value, the point in time, especially a predetermined point in time, for closing the valve is corrected during the filling procedure. A correction can, thus, for example, only be performed, when a change of the flow rate exceeds a threshold value. For example, a tolerance band in the form of a first and a second threshold value, for example, above, respectively below, a predetermined flow rate, can be provided, in order to correct the point in time for closing the valve during the filling procedure in the case of a rising, respectively falling, flow rate.

In an additional form of embodiment of the method, the point in time for closing the valve is so corrected that the defined amount of fill is filled into the container. In order always to fill the desired amount of fill into a container, the point in time for closing the valve is selected in such a manner, for example, by having the control unit of a filling plant produce a corresponding signal (close command) for closing the valve, that the valve closing amount expected due to the changed flow rate and the flow amount already registered, for example, by the control unit, up to the point in time of the producing of the signal for closing the valve correspond to the desired amount of filling.

In an additional form of embodiment of the method, the point in time for closing the valve is ascertained based on the change, respectively based on a rate of change, of the flow rate. Instead of calculating the expected valve closing amount and correcting the point in time for closing the valve based on this calculating, the point in time for closing the valve can also be corrected directly based on the changed flow rate. This can happen, for example, by means of stored correction values, for example, based on a calibration.

In an additional form of embodiment of the method, the point in time for closing the valve is determined by a desired value, which desired value corresponds to the defined amount of fill minus a valve closing correction.

In an additional form of embodiment of the method, the desired value corresponds to a value of a measurement signal, respectively a number of measurement signals, especially preferably a number of pulses. The registering of the measurement signals can occur, for example, in the control unit of the filling plant. Stored in this control unit can also be the desired value, respectively the desired value can be fitted to the changed flow rate by means of the control unit.

In an additional form of embodiment of the method, the desired value is corrected during the filling procedure in the case of a change of the flow rate, especially increased, in case the flow rate increases and/or reduced, in case the flow rate decreases. To this end, a first threshold value can be provided above, and/or a second threshold value below, a predetermined flow rate. In this way, an air bubble detection is possible, for example. Instead of a predetermined flow rate, especially a constant, predetermined flow rate, also a variable flow rate can be used, which, for example, is formed from preceding values of the flow rate, preferably during the same filling procedure. The first and/or second threshold value can then be fitted around particular flow rates of this variable flow rate, especially in such a manner that always an essentially constant separation exists between the variable flow rate and the first, respectively second, threshold value.

In an additional form of embodiment of the method, based on the change of the flow rate during the filling procedure, a valve closing amount is determined, respectively ascertained from stored values, and a conforming correction of the desired value effected.

In an additional form of embodiment of the method, upon reaching the desired value, for example, when the measurement signal reaches the desired value or, especially, a number of pulses corresponds to the desired value, a signal for closing the valve is produced. This comparison between a desired value and an actually received number of measurement signals, preferably pulses, can be performed by means of the above-mentioned control unit. The control unit can be connected with the flow measuring device and/or the valve, for example, via a communication connection, preferably in the form of a fieldbus.

In an additional form of embodiment of the method, the desired value is fitted multiple times, especially continuously, to the ascertained flow rate during a filling procedure.

In an additional form of embodiment of the method, based on the measurement signals, for example, measurement signals received by a control unit during the filling procedure, especially based on the received pulse signals, an average flow rate is determined, based on which average flow rate the desired value is ascertained.

In an additional form of embodiment of the method, at different points in time, especially over a plurality of intervals, during the filling procedure, values of the flow rate are determined, in order to determine a change of the flow rate. During these intervals, in each case, one or more measured values of the flow rate can be determined. In such case, the intervals can be intervals overlapping or directly adjoining one another. As a result, one or more average values of the flow rate can be formed, in order to determine a valve closing amount, respectively to predict and/or based on the at least one measured value of the flow rate to correct the point in time for closing the valve.

In an additional form of embodiment of the method, the change of the flow rate registered during the filling procedure serves for ascertaining a valve closing amount for the filling procedure.

As regards the filling apparatus, the object is achieved by a filling apparatus, especially control system, for performing the method according to one of the preceding forms of embodiment. Such a filling apparatus can comprise one and/or a number of filling locations, which serve for filling, in each case, one or, in each case, a number of containers. A filling location can, in turn, comprise a flow measuring device and a valve. Furthermore, a computer based control unit can be part of the filling plant and be connected with the one and/or the number of filling locations, i.e. with the flow measuring device and the associated valve, via a shared communication line or mutually separated communication lines.

Especially, in the case of a plurality of filling locations, the proposed method can be performed for all of these filling locations or only a part of the filling locations. Especially, the filling procedure can be performed at all the filling locations at the same time. On the other hand, it is also possible to perform the filling procedure at one filling location offset in time relative to the filling procedure at another filling location.

Moreover, an option is to use correction values of one filling location for control, respectively correction, of the filling procedure at another, especially following, preferably directly following, filling location, preferably of the same filling apparatus.

As regards the computer program, respectively the computer program product, the object is achieved by a computer program, respectively computer program product, having program code means, which, when executed, serve to perform the method according to one of the aforementioned forms of embodiment. In the case of the computer program product, it can be a volatile and/or non-volatile data carrier. The program code means can exist in a programming language, especially a logic. Especially, the computer program product can have a processor, which serves for performing the program code means. The computer program, respectively the computer program product, can especially be stored in a control unit of a filling plant or be executable there.

The invention will now be explained in greater detail based on the appended drawing, the figures of which show as follows:

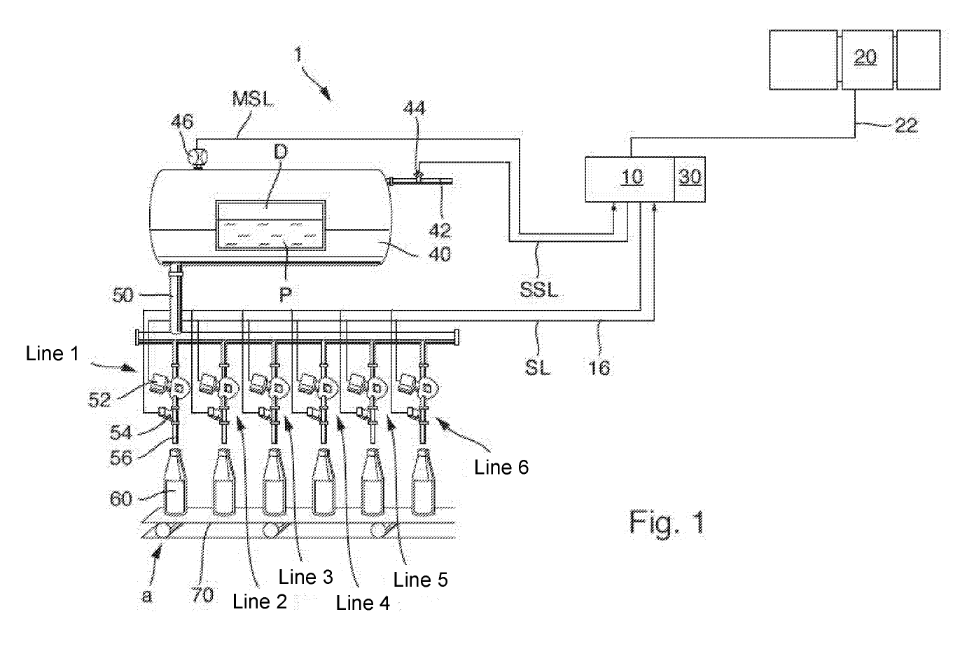

FIG. 1 a schematic representation of a filling plant, here a bottling plant;

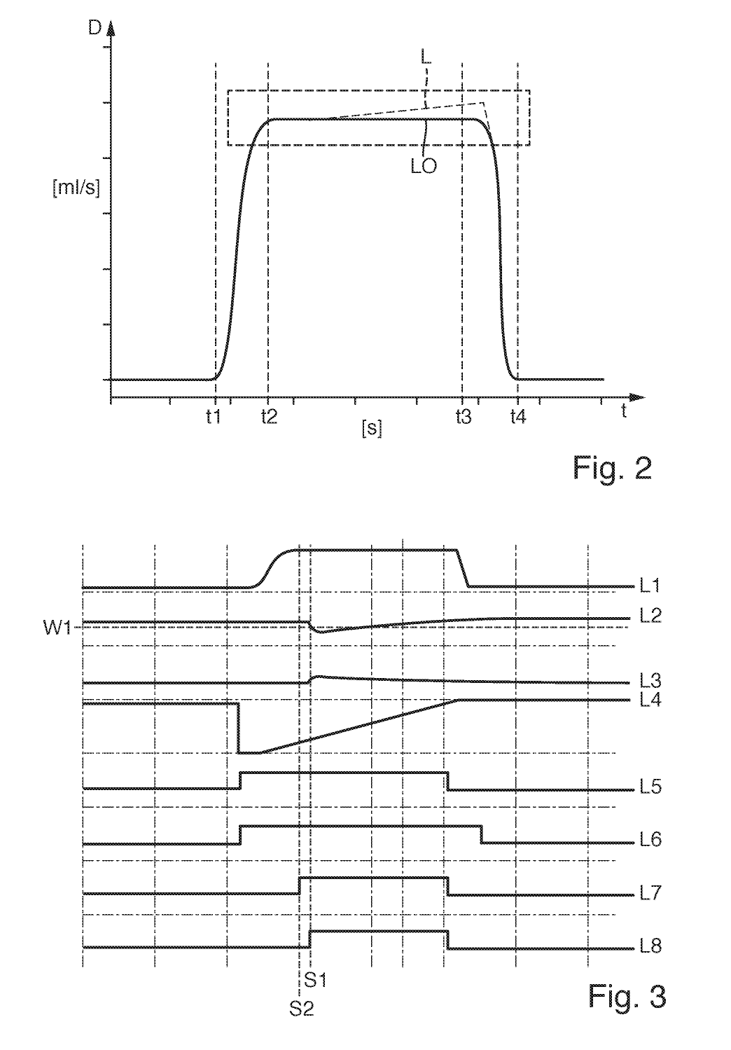

FIG. 2 a filling curve with constant, respectively changing, flow rate during the filling procedure; and

FIG. 3 curve L1 flow rate during the filling procedure, curve L2 average flow rate, curve L3 correction value for determining the closing point in time for the filling valve, curve L4 flow amount during the filling procedure, curve L5 opening signal for filling valve, curve L6 measurement signal registration during the filling procedure, curve L7 control signal for correction value formation, and curve L8 time span for performing a correction of the desired value for determining the closing point in time of the valve.

FIG. 1 shows a filling apparatus 1, such as is applied in different branches of industry. The fluid medium P is provided in a reservoir 40, here in the form of a tank. Reservoir 40 is connected via a main supply line 50 with the individual filling locations, which are referred to as lines 1 to 6. For reasons of perspicuity, only one filling location L1 is provided with reference characters. Each of the filling locations includes a flow measuring device 52 and a filling valve 54. Via the valve 54, the medium P is filled into the container 60, here in the form of a bottle to be filled. The containers, in this case, are brought via a conveyor belt 70 to the individual filling locations. The flow measuring devices 52 and the filling valves 54 are connected via signal lines 16 and control signal lines SL with a control unit 10.

Control unit 10 is modularly constructed. It is composed, for example, of a power supply, a central computing unit, a fieldbus communication unit, a digital pulse input unit, for example, having a number of inputs, a digital pulse output unit, likewise multiple, and a 4-20 mA unit, likewise multiple.

Via a bus connection line 22, the dosing, metering control unit 10 is connected with a central control unit 20. Communication between the metering control unit 10 and the central control unit 20 occurs, for example, according to the Profibus DP standard, wherein the metering control unit 10 functions as slave and the control unit 20 as master. Control unit 20 controls the entire delivery and removal of the containers 60 to the individual filling locations. The entire filling cycle for each group of containers takes, in such case, for example, 5 seconds.

Metering control unit 10 is further connected with a local display unit 30, which is embodied, for example, as a touch screen, via which the configuring of the filling plant occurs. Control unit 10 and/or 20 can naturally also be compactly executed and arranged within one housing.

In order to obtain steady filling conditions, the pressure D in the reservoir 40 is held constant. For this, a pressure meter 46 is provided on the reservoir 40 for measuring the pressure D in the container 40. The pressure D can be set via a pressurized air supply line 42, in which a valve 44 is provided. The corresponding control of the headspace pressure occurs likewise via the metering control unit 10. For this, the current pressure D is transmitted as a 4-20 mA signal via the measurement signal line MSL to the metering control unit 10. Via the control signal line SSL, the valve 44 is correspondingly operated by the metering control unit 10, in order to hold the pressure D in the container 40 constant.

In spite of these measures, pressure fluctuations can occur in the filling, when, for example, not all valves of the filling plant open, whereupon the flow through the opened valves rises.

The course of a filling curve LO with flow rate changing during the filling procedure is shown in FIG. 2, where flow rate [ml/s] is plotted versus time [s].

The filling procedure is started at a point in time t1 by a corresponding signal to a valve, whereupon the valve opens. As the valve opens after receipt of this signal, the flow rate does not rise abruptly but, instead, continuously, so that only at a point in time t2 is an approximately constant flow rate achieved—i.e. the flow becomes constant when the valve is completely open. This behavior upon opening of the valve is also referred to with the phrase, valve opening.

The curve L0 of the flow rate remains ideally essentially constant in a time span following point in time t2 after the opening of the valve, until the defined amount of fill has been filled into the container, respectively until a signal for closing the valve, for example, at a point in time t3, is sent to the valve. After obtaining this signal, the valve closes. Since this procedure, same as the opening of the valve, requires a certain amount of time, there flows through the valve and into the container in this time span between the points in time t3 and t4, when the valve is closed, a certain amount of the medium, referred to as the valve closing amount.

In the case of an approximately constant flow rate, also this valve closing amount always remains the same, so that a correction of the point in time for closing the valve can be performed, in order to fill the desired, defined fill amount into the container.

During the filling procedure, however, fluctuations in the flow rate can occur. If the flow rate follows, for example, the curve L illustrated in FIG. 2 by means of the dashed line, thus the flow rate increases even after the valve is completely opened, then also the valve closing amount increases by a corresponding value, since during the time span, which the valve requires for closing (this remains, as a rule, constant), then also more medium is filled into the container.

In order to correct for this increased valve closing amount, it is provided, not only to determine the flow amount (total flow) during the filling, but, instead, also to determine the flow rate and to establish as a function of flow rate the point in time t3 in such a manner that the desired, defined amount of fill is really filled.

In the case of a filling rate L increasing during the filling procedure (after the valve opening, i.e. after the complete opening of the valve), for example, the point in time for closing the valve can occur sooner compared with a reference point in time, and in the case of a decreasing flow rate, the point in time for closing the valve can occur correspondingly later compared with a reference point in time, since the valve closing amount is then smaller.

Before the beginning of the filling procedure at the time t1 and after the end of the filling procedure at the time t4, there is no flow through the valve, respectively no medium is filled into the container.

FIG. 3 shows the curve L1 for the flow rate during the filling procedure, curve L2 the average flow rate, curve L3 the correction value for determining the closing point in time of the filling valve, curve L4 the flow amount during the filling procedure, curve L5 the opening signal for the filling valve, curve L6 the measurement signal registered during the filling procedure, and curve L7 the control signal for correction value formation. The curves are presented one over the other, so that equal points in time lie on top of one another.

The curve L1 shows a curve of flow rate quite similar to that of curve L in FIG. 2, in the case of which the flow rate changes during the filling procedure. With increased resolution, curve L2 for the average flow rate shows that at a point in time s1 the flow rate lessens and then rises gradually to the original value. By lessening the flow rate at point in time s1, the counter value L3, which serves for determining the closing point in time, is increased as shown in the curve of the counter value L3, so that the valve remains open longer compared with a reference value, respectively reference point in time. With (medium) flow rate rising again, also the counter value falls again, back approximately to the starting value.

The curve L4 for the sum of the counter versus time, which corresponds to the curve for the flow amount filled, is ramp shaped. The counter corresponds, in such case, to the number of pulses output from the flow measuring device. The number of pulses rises in such case linearly during the filling procedure. As a function of the flow rate, different sections of the ramp can also have different slopes.

A comparison of the curve L5 of the signal for opening the valve and the counter, respectively flow rate, shows that, after sending the signal, it takes a certain length of time until the valve is completely opened and the flow has stabilized to a constant value. This can be seen in the delayed response of the counter L4 and the flow rate L1 in comparison with the signal for the opening of the valve L5.

The curve L6 for the measurement signal registering during the filling procedure begins with the sending of the signal for opening the valve and continues beyond the signal for closing the valve, so that also the valve closing amount is registered in the form of the measurement signal and is transmitted as a pulse to the control unit, and, thus, the actual filled amount of the medium is registered.

The registering of the flow rate for correction purposes begins, as shown in the curve L7, at a point in time s2 after the complete opening of the valve. This registering of the flow rate begins after the flow has leveled off following the opening of the valve. After an average value of the flow rate has been ascertained, also the correction of the counter value for closing the valve can occur.

The time span, in which a correction of the desired value for determining the closing point in time of the valve is performed, is shown by the curve L8.

A value for volume- or mass flow (units e.g. ml/s or g/s) is generated from counted pulses per unit time. The number of pulses determines the volume or the mass (units e.g. ml or g), thus the metered amount, respectively the flow amount.

A counter card, which can be, for example, part of the control unit, counts the pulses, which are defined in the flow measuring device (e.g. 0.02 ml/pulse). At the end of the dosing or metering cycle, e.g. 5000 pulses have been counted, which in the case of 0.02 ml/pulse corresponds to 100 ml. The desired dosed or metered amount (e.g. 100 ml, which corresponds in the mentioned example of 5000 pulses) is defined with a desired value in a program, which runs, for example, in the control unit. When the counter reaches the 5000 pulses, the valve closes.

Since, however, from the point in time of the closing command up to the point in time, at which the valve is completely closed, further medium is filled into the container, this leads to e.g. 5200 pulses being counted by the end of the dosing or metering cycle, instead of the desired 5000.

After the dosing or metering cycle, the actual value (counter reading) is subtracted from the desired value and the result used for determining the new desired value. The difference is the valve closing correction. Thus, the new desired value in the above-mentioned example is 96 ml (4800 pulses).

The calculated, new desired value is only used within the above-mentioned program. On a display presented to a user, 100 ml is still displayed. The actual value (counter reading) is set to zero before the start of each new filling procedure. Since the closing behavior of the valve from dosing or metering cycle to dosing or metering cycle is basically not essentially changed, exactly 100 ml should be dosed in the next dosing or metering cycle, even though the valve received the close command at 96 ml.

The closing behavior of the valve is only the same from filling procedure to filling procedure, when the volume- or mass flow does not change (e.g. because of higher pressure in the supply tank). If, now, the volume- or mass flow does, however, change during the next dosing or metering cycle, in spite of this, the valve is closed at 96 ml. The valve closing amount is, however, greater and, thus, too much is metered or dosed. This is, indeed, corrected in the next dosing or metering cycle, however, this is too late, in order to fill exactly the desired amount of fill into a container.

Therefore, the volume- or mass flow must be dynamically monitored during a filling procedure, in order to change the desired value dynamically during the filling procedure.

In the case of the proposed method, such as above described, the actual value after the filling procedure is subtracted from the desired value and so the new desired value for the next filling procedure defined. However, now the volume- or mass flow is dynamically registered during the filling procedure and the desired value dynamically corrected by a factor, which is calculated from the change of the volume- or mass flow.

The volume- or mass flow value, which is used for these factors, can, in such case, be determined as follows: The above-mentioned program, which is running, for example, on the control unit, ascertains when the valve is completely open and the volume- or mass flow has leveled off to a preliminary steady-state value (for example, 100 ms after the start command). Then, another 100 ms is waited, in order not to register possibly occurring startup fluctuations. Thereafter, for example, volume- or mass flow values are registered every 10 ms and the average of these measured values formed, until the close command of the valve comes. This volume- or mass flow average value is used in the next filling procedure as start reference. Thus, the desired value for the next filling procedure is adjusted with this old average value relative to the new volume- or mass flow average value and, thus, the desired value is dynamically changed during the ongoing filling procedure.

In order that disturbance signals or short peaks in the volume- or mass flow not affect the average value, a hysteresis can be defined by means of one or more threshold values. By means of the hysteresis, it can be determined, which deviation in the case of a just registered volume- or mass flow compared to the previously registered volume- or mass flow is still tolerable for the average value.

The individual volume- or mass flow values are, for example, registered every 10 ms. Thus, when within this interval the volume- or mass flow values change above or below the limits of the hysteresis, this volume- or mass flow value is not used for the average. An interval can also be defined, in order to increase the 10 ms period. Then the average of the volume- or mass flow values is formed within an interval and these interval average values are then used to check the limits of the hysteresis. Then also the volume- or mass flow interval average values are used to generate the volume- or mass flow total average.

1-15. (canceled)

16. A method for valve-controlled filling of a defined amount of fill of a medium into a container, comprising the steps of:
ascertaining a flow rate of the medium based on a measurement signal representing a flow amount during a filling procedure; and
based on a change of the flow rate during the filling procedure a point in time for closing a valve, which serves for filling, is corrected during the filling procedure.

17. The method as claimed in claim 16, wherein:
in the case of a change of the flow rate during the filling procedure, which change lies above a predetermined threshold value, the predetermined point in time for closing the valve is corrected during the filling procedure.

18. The method as claimed in claim 16, wherein:
the point in time, especially a predetermined point in time, for closing the valve is so corrected that the defined amount of fill is filled into the container.

19. The method as claimed in claim 16, wherein:
the point in time for closing the valve is ascertained based on said change, respectively a rate of change, of said flow rate.

20. The method as claimed in claim 16, wherein:
the point in time for closing the valve is determined by a desired value, which corresponds to the defined amount of fill minus a valve closing correction.

21. The method as claimed in claim 20, wherein:
said desired value corresponds to a value of a measurement signal, respectively a number of measurement signals, especially preferably a number of pulses.

22. The method as claimed in claim 20, wherein:
said desired value is corrected during the filling procedure in the case of a change of the flow rate, especially increased, in case the flow rate rises, or reduced, in case the flow rate decreases.

23. The method as claimed in claim 20, wherein:
based on said change of the flow rate during the filling procedure, a valve closing amount is determined, respectively ascertained from stored values, and a conforming correction of said desired value effected.

24. The method as claimed in claim 20, wherein:
upon reaching said desired value, for example, when the measurement signal reaches said desired value or, especially, a number of pulses corresponds to said desired value, a signal for closing the valve is produced.

25. The method as claimed in claim 20, wherein:
said desired value is fitted multiple times, especially continuously, to said ascertained flow rate during a filling procedure.

26. The method as claimed in claim 20, wherein:
based on the measurement signals, for example, measurement signals received by a control unit during the filling procedure, especially based on the received pulse signals, an average flow rate is determined, based on which average flow rate said desired value is ascertained.

27. The method as claimed in claim 16, wherein:
at different points in time, especially over a plurality of intervals, during the filling procedure, values of said flow rate are determined, in order to determine said change of said flow rate.

28. The method as claimed in claim 16, wherein:
said change of the flow rate registered during the filling procedure serves for ascertaining a valve closing amount for the filling procedure.

29. A filling apparatus control system, for performing the method as claimed in claim 16.

30. A computer program product having program code means, which when executed, serve to perform the method as claimed in claim 16.
